(19) United States
(12) Patent Application Publication
(10) Pub. No.: US 2005/0036538 A1
(43) Pub. Date: Feb. 17, 2005

(54) Method and apparatus for calculation of correction factors for path weights in a rake receiver

(76) Inventors: Jurgen Niederholz, Kerken (DE); Burkhard Becker, Ismaning (DE); Robert Denk, Grafing (DE)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 10/875,839

(22) Filed: Jun. 24, 2004

(30) Foreign Application Priority Data
Jun. 24, 2003 (DE) DE 103 28 341.2

(51) Int. Cl. H04B 1/707

(52) U.S. Cl. 375/148

(57) ABSTRACT

A method for calculation of path weights for the equalization of a data signal, that is transmitted via a data channel whose power is regulated, in a RAKE receiver is disclosed. In the method, a path weight is calculated for the data signal that is transmitted via the data channel whose power is regulated and a correction factor is calculated for the path weight. The correction factor includes a ratio of the data-channel-specific gain to the pilot-channel-based gain, and the selection of the common pilot symbols that are used for this purpose depending on the receiver velocity or the time slot format.

### REFERENCE TO RELATED APPLICATIONS

This application is related to U.S. application Ser. No. ______ (Attorney Docket No. LLP129US), filed on Jun. 24, 2004, entitled “METHOD AND APPARATUS FOR CALCULATION OF PATH WEIGHTS IN A RAKE RECEIVER”, and U.S. application Ser. No. (Attorney Docket No. LLP131US), filed on Jun. 24, 2004, entitled “METHOD AND APPARATUS FOR WEIGHTING CHANNEL COEFFICIENTS IN A RAKE RECEIVER,” both of which are hereby incorporated by reference in their entirety.

This application claims the benefit of the priority date of German application DE 103 28 341.2, filed on Jun. 24, 2003, the contents of which are herein incorporated by reference in their entirety.

### FIELD OF THE INVENTION

The invention relates to a method and an apparatus for calculation of path weights for the equalization of a data signal, which is transmitted via a data channel whose power is regulated, in a RAKE receiver.

### BACKGROUND OF THE INVENTION

In mobile radio systems, the signals are transmitted from a base station to a mobile station (downlink) and from a mobile station to a base station (uplink) via so-called physical channels. The physical channels in a mobile radio system are specified by standardization. In the case of a CDMA (Code Division Multiple Access) transmission system, each physical channel is characterized by a specific carrier frequency, regulations for the spread coding and a specific data structure.

The channels which are provided in the UMTS (Universal Mobile Telecommunications System) Standard are defined in the UMTS Specification 3GPP TS 25.211 V4.4.0 (2002-03).

In general, a distinction is drawn between common physical channels (Common Pilot Channel; CPICH) via which data that is intended for all the subscribers is transmitted, and dedicated physical channels (DPCH), via which subscriber-specific data is transmitted.

Common pilot symbols, which are known a priori to the receiver and which are used for synchronization and measurement purposes, are transmitted via the CPICH channel. The data transmission via the DPCH channel comprises not only subscriber-specific payload data symbols, but also dedicated pilot symbols. The dedicated pilot symbols are used in precisely the same way as the common pilot symbols for synchronization and measurement purposes.

During transmission between the base station and the mobile station, the radio signals are reflected, scattered or diffracted on various obstructions in the propagation path, which results in a number of radio signal versions occurring at the receiver, which are shifted in time with respect to one another.

In a CDMA transmission system, the radio signals are typically received by a RAKE receiver. The method of operation of a RAKE receiver is based on the signal contributions which reach the receiver via different transmission paths being weighted and added up in a synchronized form. The RAKE receiver has a number of RAKE fingers for this purpose, whose outputs are connected to a combiner. During operation, the fingers are associated with the individual propagation paths, and carry out the path-specific demodulation process (delay, despreading, symbol formation, multiplication by the path weight). The combiner superimposes those signal components which are transmitted via different propagation paths but are associated with the same signal.

In order to achieve a maximum signal-to-noise power plus interference ratio (SINR) for the overall signal produced by path combination, the so-called Maximum Ratio Combining (MRC) process is frequently used for weighting the individual transmission paths. In the case of MRC, the individual path-specific signal contributions are weighted on the basis of their path-specific SINR, and are then added up.

The channel estimation process can be carried out, for example, on the basis of the common pilot symbols which are transmitted via the CPICH channel. This channel estimation process is preferred rather than channel estimation based on dedicated pilot symbols, since the number of dedicated pilot symbols in one time slot is frequently not sufficient for accurate channel estimation.

When using the CPICH channel for calculation of the path weights of a data channel to be demodulated, the channel characteristic of the physical transmission channel is admittedly measured more or less appropriately, but a problem arises in that any regulation of the power of the data channel signal path at the transmitter is ignored. This leads to a loss of performance during the further processing of the combined signal, particularly during its decoding.

### SUMMARY OF THE INVENTION

The problem of ignoring power regulation can be overcome by first of all calculating an uncorrected path weight using channel estimation results which have been obtained on the basis of a common pilot channel, and by then correcting this uncorrected path weight by multiplying it by a correction factor f. The calculation of the uncorrected path weight is described in the German Patent Application No. 103 28 340.4 entitled, “Method and apparatus for calculation of path weights in a rake receiver” and is hereby incorporated by reference in its entirety in the present application.

For example, the uncorrected path weights may be calculated in various ways depending on the options that the transmission system provides and the technical complexity of the receiver. One low-complexity option is binary weighting, in which only the propagation path with the best quality is used. One typical quality measure is the signal-to-noise power plus interference ratio (SINR) of the received data symbols. In this procedure, only a single RAKE finger is required for each data channel to be equalized.

One further frequently used option is to provide for exclusive consideration of the path-specific signal phases with the magnitudes of all the path contributions being given equal weighting.

The optimum weighting of the individual paths in the sense of the maximum SINR for the overall signal produced by path combination is achieved by the so-called Maximum Ratio Combining (MRC) process. In the case of MRC, the individual path-specific signal contributions are weighted on the basis of their path-specific SINR, and are then added up.

Various aspects may be taken into account for calculation of the path weights: if the aim is to equalize a data channel that contains pilot symbols (that is to say symbols that are known in the receiver), these symbols may be used for channel estimation, that is to say for calculation of the path weights. A situation such as this occurs in the case of the UMTS (Universal Mobile Telecommunications System) Standard for example for the dedicated (Subscriber Specific) data channel DCH (Dedicated Channel). However, this procedure has the disadvantage that the number of pilot symbols in one time slot is frequently not sufficient for accurate channel estimation.

Another possibility is to carry out the channel estimation process on the basis of a common pilot channel (that is to say a pilot channel that is intended for all the subscribers), that is provided by the base station. One channel that is suitable for this purpose in the UMTS Standard is the P-CPICH (Primary Common Pilot Channel). Calculation of channel weights on the basis of the P-CPICH has good statistics. It is generally therefore preferred for channel estimation based on dedicated pilot symbols (for example for the DCH). Data channels that contain no dedicated pilot symbols—for UMTS this applies, for example, to the common downlink data channel DSCH (Downlink Shared Channel)—necessarily have to be dedmodulated by calculation of channel weights on the basis of a common pilot channel.

When using a common pilot channel for calculation of the path weights for a data channel to be demodulated, the channel characteristic of the physical transmission channel is admittedly measured more or less appropriately, but this results in the problem that transmitter power regulation of the data signal path is ignored. This leads to a loss of performance in the further processing of the combined signal, particularly during its decoding.

In any event, upon an uncorrected path weight being calculated, the uncorrected path weight is then corrected in accordance with the present invention by determining and applying a correction factor thereto.

The correction factor f is composed of two factors. The first factor represents the ratio of the estimated gain W_{D} in the channel whose power is regulated to the estimated gain W_{C} based on the CPICH channel. This ratio compensates for the power regulation in the channel whose power is regulated. In order to satisfy the MRC principle, the correction factor f includes, as a second factor, the inverse cell-specific noise variance σ_{D}² on the channel whose power is regulated. Overall, the correction factor f is in the following form:

$$f = \frac{{W}_{D}}{{W}_{C}} \cdot \frac{1}{{σ}_{D}^{2}} \qquad ( 1 )$$

The estimated gain value W_{D} can be calculated by addition of the squares of the magnitudes of dedicated payload data symbols or of the squares of the magnitudes of dedicated pilot symbols. The estimated gain value W_{C} is determined by addition of the squares of the magnitudes of common pilot symbols. In this case, the common pilot symbols may also be replaced by channel coefficients calculated from the common pilot symbols.

Correction by means of the factor W_{D}/W_{C} takes account of the influence of the power regulation and means that correctly MRC-weighted data symbols are always emitted from the RAKE receiver over the entire length of a code word which comprises a number of data frames, and can thus be used for further data processing, in particular for decoding.

The factor 1/σ_{D}² also makes it possible to take account of noise power levels which vary with time. In this case, it is assumed that all the transmission paths in one cell have the same noise variance.

All of the variables in the correction factor f must be determined from measurements based on time slots, so that they can be used for correction of the MRC-combined symbols in the next time slot.

The previous methods which have been used for determination of the correction factor f do not take sufficient account of the fact that the inhomogeneities in the mobile radio channel, which in the end lead to multipath propagation of the radio signal, cannot be regarded as being stationary, but are influenced in particular by movements of the mobile station. The propagation of the waves in the mobile radio channel, which is governed not only by shadowing but also by different propagation paths, changes as soon as the position of the mobile station is varied. The fluctuation in the received power that is caused by this is referred to as fading.

The rate at which the changes in the channel state occur is generally related directly to the relative velocity of the mobile station with respect to the base station. When the relative velocities are high, fading dips may occur within a few symbols. This results in performance losses as a result of an incorrectly calculated factor W_{D}/W_{C}. This is because the dividend of the quotient W_{D}/W_{C}is calculated either by adding up the squares of the magnitudes of the dedicated payload data symbols or by adding up the squares of the magnitudes of the dedicated pilot symbols. These data fields each occupy only a part of one time slot. In contrast, the common pilot symbols are transmitted continuously, so that the addition of the squares of the magnitudes of the common pilot symbols, in order to calculate the divisor of the quotient W_{D}/W_{C}, extends over a longer time period. This can lead to the dividend possibly not being affected at all by a fading dip, while the divisor represents an integration over the fading dip. Furthermore, in the UMTS Standard, the data fields of the DPCH channel have different lengths, depending on the time slot format (slot format). In particular, the dedicated pilot field may in some circumstances be restricted to a small number of symbols. This can lead to a considerable performance loss.

The invention is based on the object of specifying a method which provides for accurate calculation of path weights for the equalization of a data signal by means of a RAKE receiver. One particular aim is to take account of the relative velocity of the mobile station with respect to the base station, as well as the position and number of the dedicated payload symbols and the dedicated pilot symbols within one time slot. A further aim of the invention is to provide an apparatus having the stated characteristics.

The method according to the invention is used for calculation of path weights for the equalization of a data signal which is transmitted from a base station via a data channel whose power is regulated, in a RAKE receiver in a mobile station.

In a first method step, at least one uncorrected path weight is calculated for the data signal which is transmitted via the data channel whose power is regulated, using channel estimation results obtained on the basis of a common pilot channel.

In a second method step, a correction factor is calculated, which comprises the ratio of a first estimated gain value, which is related to the data channel whose power is regulated, to a second estimated gain value, which is related to the common pilot channel. The common pilot symbols which are used for calculation of the second estimated gain value are selected as a function of the relative velocity of the mobile station with respect to the base station, and/or of the position and number of the symbols which are used for calculation of the first estimated gain value.

The relative velocity is calculated using a method which is known to those skilled in the art. Apparatuses which are used for this purpose are cited, for example, in the German Patent Application No. 102 13 517.7 entitled, “Apparatus for determination of the relative velocity between a transmitting device and a receiving device,” which is hereby incorporated by reference in its entirety. Furthermore, apparatuses for determination of the relative velocity are known from the documents WO 2001/69960 A1 and WO 2000/08482 A1, and such documents are also incorporated herein by reference in their entirety.

In a third method step, the at least one uncorrected path weight is corrected by multiplying it by the correction factor.

Taking account of the relative velocity of the mobile station with respect to the base station allows the interval in which the common pilot symbols are used for calculation of the second estimated gain value to always be chosen such that it is optimally matched to the respective conditions. If the relative velocity is low, the interval may, for example, extend over an entire time slot, thus contributing to improved statistical validity of the correction factor. If the relative velocity is high, the interval may, for example, be defined such that it is largely coincident with the interval in which the symbols are used for calculation of the first estimated gain value. This means that the symbols which are used as the basis for determination of the first and second estimated gain values have been subjected to the same channel influences during their transmission. This means that the channel influences from the quotient to be formed are cancelled out during the calculation of the correction factor in the second method step. This minimizes the influence of fading dips on the correction factor.

The same result is achieved if the interval for calculation of the second estimated gain value is matched to the position and the number of the symbols which are used for calculation of the first estimated gain value. In the UMTS Standard, by way of example, this is provided by matching to the time slot format.

Common pilot symbols that have been transmitted largely at the same time as the symbols that are used for calculation of the first estimated gain value can preferably be used for calculation of the second estimated gain value. In consequence, as described above, channel influences on the estimation results are largely eliminated.

As an alternative to this, it is also possible to provide in a preferred manner for common pilot symbols that have been transmitted largely at the same time as the symbols that are used for calculation of the first estimated gain value to be used for calculation of the second estimated gain value if the relative velocity of the mobile station with respect to the base station is above a predetermined limit value. This leads to a performance gain by exclusion of fading dips when the relative velocities are high.

Furthermore, if the relative velocity is below the predetermined limit value, the common pilot symbols which are transmitted in a predetermined time interval are advantageously used for calculation of the second estimated gain value. As a maximum, the predetermined time interval may extend over one time slot. If the velocities are low, the channel characteristics change only slowly, so that fading dips need not be taken into account in this case. In consequence, averaging can be carried out over a longer time period. This leads to the correction factor being more accurate.

The correction factor is preferably calculated using the following equation (2):

$$f = \frac{{W}_{D}}{{W}_{C}} \cdot \frac{1}{{σ}_{D}^{2}} \qquad ( 2 )$$

In equation (2), W_{D} denotes an estimated value for the transmitter gain of the data channel whose power is regulated, W_{C} denotes an estimated value for the transmitter gain of the common pilot channel, and σ_{D}² denotes an estimated value for the noise variance on the data channel whose power is regulated.

According to one preferred refinement of the invention, the second estimated gain value is calculated from channel coefficients which have previously been calculated from the selected common pilot symbols.

The data channel whose power is regulated is preferably a DPCH channel based on the UMTS Standard.

In principle, the method according to the invention may be used for less-complex equalization which takes account of only one transmission path for each signal. However, two or more uncorrected path weights are advantageously calculated for two or more transmission paths of the data signal in a specific mobile radio cell, and all of the uncorrected path weights for this mobile radio cell are multiplied by the same correction factor. This takes account of the influence of the power regulation in the combined signal, that is to say in the signal which is formed by the superimposition of the path-specific signal components.

A further preferred refinement of the invention provides for dedicated payload data symbols and/or dedicated pilot symbols to be used for calculation of the first estimated gain value. If a time slot contains only a few dedicated pilot symbols, then it is recommended that the calculation of the correction factor be restricted to the dedicated payload data symbols.

Furthermore, the operating mode of the base station must be taken into account in the calculation of the correction factor. By way of example, in the UMTS Standard, the base station may be operated in the normal mode, in the STTD mode (Space Time Transmit Diversity) and in the CLTD mode (Closed Loop Mode Transmit Diversity). In the normal mode, the radio signal is transmitted from only one base station antenna. In this case, the same common pilot symbol is always transmitted continuously. In the STTD mode, two antennas are provided for the transmission of the radio signal. In the CLTD mode, the radio signals are likewise transmitted from two antennas, but, in the CLTD mode, the phase relationship and possibly the amplitudes of the signals transmitted from the two antennas are additionally designed to be variable. This makes it possible to select constructive interference between the transmission channels originating from the two antennas, at the receiver end. Both in the STTD mode and in the CLTD mode, the common pilot symbols are transmitted using a repetitive pattern A, −A, −A, A. The common pilot symbols which are used for calculation of the second estimated gain value are advantageously selected as a function of the base station operating mode.

A further particularly preferred refinement of the invention is characterized in that the UMTS time slot formats are stored in a memory together with the associated interval boundaries within which the common pilot symbols are used for calculation of the second estimated gain value. This measure allows the interval boundaries to be output from the memory as a function of the time slot format in the second method step.

The apparatus according to the invention is used for calculation of path weights for the equalization of a data signal, which is transmitted from a base station via a data channel whose power is regulated, in a RAKE receiver in a mobile station. The apparatus according to the invention has three means for this purpose.

The first means calculates at least one uncorrected path weight for the data signal which is transmitted via the data channel whose power is regulated. Channel estimation results which have been obtained on the basis of a common pilot channel are used for this calculation.

The second means is used for calculation of a correction factor which comprises the ratio of a first estimated gain value, which is related to the data channel whose power is regulated, to a second estimated gain value, which is related to the common pilot channel. In this case, the selection of the common pilot symbols which are used for calculation of the second estimated gain value depends on the relative velocity of the mobile station with respect to the base station and/or on the position and number of the symbols which are used for calculation of the first estimated gain value.

Finally, the third means is used to correct the at least one uncorrected path weight by multiplying it by the correction factor.

The apparatus according to the invention allows the path weights to be calculated accurately, and has the same advantages as the method according to the invention.

### BRIEF DESCRIPTION OF THE DRAWINGS

The invention will be explained in more detail in the following text in an exemplary manner with reference to the drawings, in which:

FIG. 1 shows the data structure of the DPCH channel;

FIG. 2 shows a schematic illustration of a first exemplary embodiment of the method according to the invention for a UMTS time slot format 6; and

FIG. 3 shows a schematic illustration of a second exemplary embodiment of the method according to the invention for a UMTS time slot format 15B.

### DETAILED DESCRIPTION OF THE INVENTION

The invention will be explained in the following text with reference to two exemplary embodiments, to be precise in explaining the calculation of corrected path weights for the UMTS time slot formats 6 and 15B.

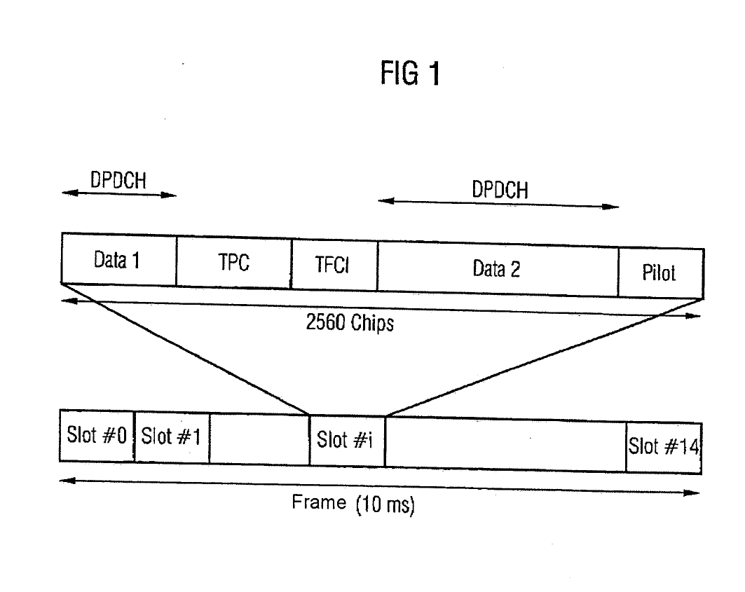

In order to assist understanding of the two exemplary embodiments, FIG. 1 shows the frame structure and time slot structure of the DPCH channel. A frame lasts for 10 ms and comprises 15 time slots. The fields Data1, TPC, TFCI, Data2 and Pilot are transmitted in each time slot. The Data1 and Data2 fields contain payload data in the form of spread-coded data symbols. These two data fields form the DPDCH (Dedicated Physical Data Channel) channel. The TPC (Transmission Power Control) field is used to regulate the power of the DPCH channel. The TFCI (Transport Format Combination Indicator) field is provided in order to signal to the receiver the transport channel transport formats on which the transmitted frame is based. The Pilot field contains dedicated pilot symbols. Overall, one time slot comprises 2560 chips. The chip time duration is then 0.26 μs.

The respective length of the fields Data1, TPC, TFCI, Data2 and Pilot, that is to say the number of chips that each of them comprise, is specified in the UMTS Specification 3GPP TS 25.211 V4.4.0 (2002-03) and to be precise in Table 11, which is contained in Section 5.3.2. Table 11 lists the respective lengths of the various fields as a function of the time slot format (slot format), and such specification is hereby incorporated by reference in its entirety.

The following analysis is based on multipath propagation in the downlink over M transmission paths m (m=1, 2, . . . M). It is assumed that synchronized reception, including the processing steps of despreading, descrambling and integration over the symbol duration, have already been carried out. The steps of despreading and descrambling are carried out by multiplication by code sequences whose energy is normalized at the chip level and—based on the normal method of operation of a RAKE receiver—they are carried out for the associated propagation path in each RAKE finger. The subsequent integration over the symbol time duration is frequently also referred to as integrate and dump, and adds the synchronized, despread and descrambled chips of one symbol. The number of chips to be added is predetermined, as is known, by the spreading factor SF of the respective channel whose signal component is demodulated in the RAKE finger. The data is produced at the symbol clock rate in the signal path downstream from the integrator.

Channel coefficients hₘ^{C}(i) for the transmission paths m of the CPICH channel under consideration are calculated within the cell under consideration on the basis of received common pilot symbols in a channel estimator. In this case, the index i (i=1, 2, . . . , 10) indicates the position of the common pilot symbol, from which the channel coefficient hₘ^{C}(i) was calculated, within a time slot.

Furthermore, channel coefficients hₘ^{D} are calculated for the transmission paths m of the DPCH channel under consideration within the cell under consideration. These calculations are carried out on the basis of received dedicated pilot symbols in the Pilot field.

In the case of the STTD and CLTD modes, it must be remembered that the signals have been transmitted from the base station by means of two antennas. In consequence, in these cases, channel coefficients h_{j,m}^{C} (j=1, 2) must be calculated for the CPICH channel, and channel coefficients h_{j,m}^{D} (j=1, 2) must be calculated for the DPCH channel.

The uncorrected path weights are then estimated on the basis of the CPICH channel as discussed above. Further details relating to this can be found in the German Patent Application No. 103 28 340.4 which has already been incorporated by reference herein.

Since the transmitter power regulation of the DPCH channels results in distortion of the estimated path weights, the received estimated results must be normalized or corrected. This correction must overcome the disadvantage (which is inherent in the estimation of the path weights) that varying gain relationships between the CPICH channel on the one hand and the DPCH channel on the other hand are ignored.

The varying gain relationships between the CPICH channel on the one hand and the DPCH channel on the other hand are taken into account by multiplying the previously estimated path weights by the correction factor f, as described in the following text:

$$f = \frac{{W}_{D}}{{W}_{C}} \cdot \frac{1}{{σ}_{D}^{2}} \qquad ( 3 )$$

The correction factor f has two factors. The first factor is given by the ratio of the received amplitude W_{D} of the dedicated payload data symbols to the received amplitude W_{C} of the common pilot symbols, or by the ratio of the received amplitude W_{D} of the dedicated pilot symbols to the received amplitude W_{C} of the common pilot symbols. This ratio compensates for the power regulation in the DPCH channel, whose power is regulated. The second factor in the correction factor f includes the noise variance σ_{D}² of the transmission paths in the cell under consideration. This is based on the assumption that all of the transmission paths in one cell have the same noise variance σ_{D}².

The received amplitudes W_{D} and W_{C} are generally determined by addition of the squares of the magnitudes of dedicated payload data symbols or of the squares of the magnitudes of dedicated pilot symbols, and addition of the squares of the magnitudes of common pilot symbols. In this case, the summation of the squares of the magnitudes of the dedicated pilot symbols can also be replaced by summation of the squares of the magnitudes of channel coefficients h_{D}^{m} which have been calculated from the dedicated pilot symbols. Furthermore, the summation of the squares of the magnitudes of the common pilot symbols can also be replaced by summation of the squares of the magnitudes of channel coefficients hₘ^{C}(i) which have been calculated from the common pilot symbols.

This results in the following two equations for the amplitude ratio W_{D}/W_{C} in the normal mode:

$$\begin{matrix}\frac{{W}_{D}}{{W}_{C}} = \frac{\sqrt{{\sum }_{m = 1}^{M} {\sum }_{k = 1}^{KData1 + KData2} {\vert {x}_{m , k}^{Data} \vert}^{2}}}{\sqrt{{\sum }_{m = 1}^{M} {\sum }_{i = B\_TS \_NData}^{E\_TS \_NData} {\vert {h}_{m}^{c} ( i ) \vert}^{2}}} & ( 4 ) \\ \frac{{W}_{D}}{{W}_{C}} = \frac{\sqrt{{\sum }_{m = 1}^{M} {\vert {h}_{m}^{D} \vert}^{2}}}{\sqrt{{\sum }_{m = 1}^{M} {\sum }_{i = B\_TS \_NPilot}^{E\_TS \_NPilot} {\vert {h}_{m}^{c} ( i ) \vert}^{2}}} & ( 5 )\end{matrix}$$

The equations for the amplitude ratio W_{D}/W_{C} for the STTD and CLTD mode, respectively, are as follows:

$$\begin{matrix}\frac{{W}_{D}}{{W}_{C}} = \frac{\sqrt{{\sum }_{m = 1}^{M} {\sum }_{k = 1}^{KData1 + KData2} {\vert {x}_{m , k}^{Data} \vert}^{2}}}{\sqrt{{\sum }_{j = 1 , 2}^{} {\sum }_{m = 1}^{M} {\sum }_{i = B\_TS \_NData}^{E\_TS \_NData} {\vert {h}_{j , m}^{c} ( i ) \vert}^{2}}} & ( 6 ) \\ \frac{{W}_{D}}{{W}_{C}} = \frac{\sqrt{{\sum }_{j = 1 , 2}^{} {\sum }_{m = 1}^{M} {\vert {h}_{j , m}^{D} \vert}^{2}}}{\sqrt{{\sum }_{j = 1 , 2}^{} {\sum }_{m = 1}^{M} {\sum }_{i = B\_TS \_NPilot}^{E\_TS \_NPilot} {\vert {h}_{j , m}^{c} ( i ) \vert}^{2}}} & ( 7 )\end{matrix}$$

In equations (4) and (6),

$${x}_{m , k}^{Data}$$

represents the dedicated payload data symbols. The index k (k=1, 2, . . . , KData1+KData2) indicates the position of the dedicated payload data symbol

$${x}_{m , k}^{Data}$$

within one time slot. KData1 and KData2 indicate the number of payload data symbols x_{m,k}^{data} in the respective data field Data1 or Data2 of the DPCH time slot.

B_TS_NData and E_TS_NData denote the integration limits of the interval over which the channel coefficients hₘ^{C}(i) and h_{j,m}^{C} (i), respectively, which have been determined from the common pilot symbols, are added up in order to calculate the divisor in equation (4) or (6), respectively.

In an analogous manner, B_TS_NPilot and E_TS_NPilot indicate the integration limits of the interval over which the channel coefficients hₘ^{C} (i) and h_{j,m}^{C} (i), respectively, which have been determined from the common pilot symbols, are added up in order to calculate the divisor in equation (5) or (7), respectively.

The squares of the magnitudes of the dedicated payload data symbols

$${x}_{m , k}^{Data}$$

in the data fields Data1 and Data2 are added up in order to calculate the dividend of equation (4) or (6), respectively.

The estimation of the channel coefficients hₘ^{D} and h_{j,m}^{C}, respectively, must have been completed for the addition of the channel coefficients hₘ^{D} and h_{j,m} ^{D}, respectively, for calculation of the dividend of equation (5) or (7), respectively. This addition process is thus restricted to the end of the dedicated pilot field Pilot.

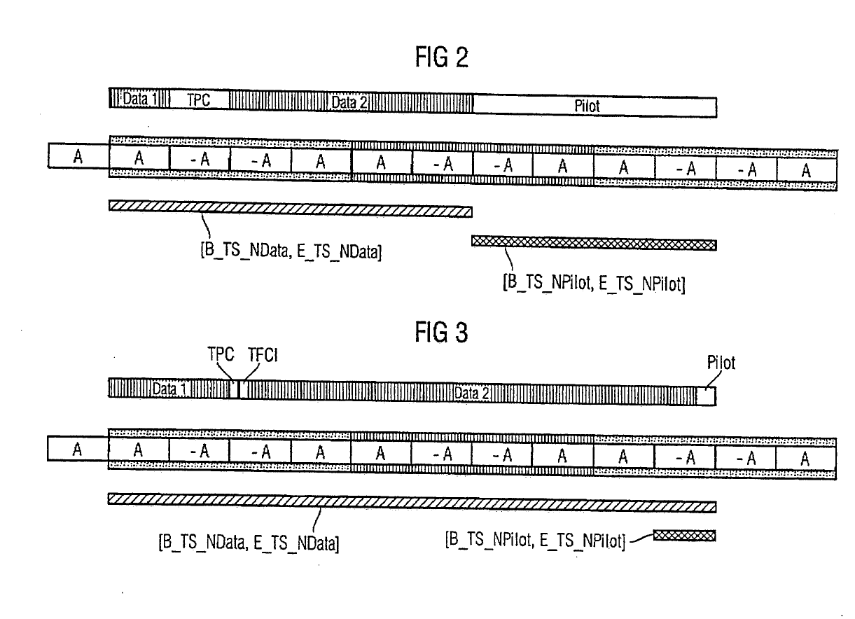

The critical factor is now that the intervals [B_TS_NData, E_TS_NData] and [B_TS_NPilot, E_TS_NPilot] for calculation of the divisors in equations (4) to (7) are selected correctly. FIGS. 2 and 3 will be referred to in the following text in order to explain the options that exist for suitable selection of the stated intervals.

One time slot in the DPCH channel is shown in the uppermost line in FIG. 2. This DPCH time slot uses the time slot format 6. The common pilot symbols which are transmitted via the CPICH channel are shown underneath the DPCH time slot. Ten common pilot symbols are transmitted in each time slot. In this case, the base station is being operated in a multi-antenna mode, that is to say either the STTD or CLTD mode. The common pilot symbols thus have the repetitive structure A, −A, −A, A.

The intervals [B_TS_NData, E_TS_NData] and [B_TS_NPilot, E_TS_NPilot] for calculation of the equations (6) and (7) are ideally selected such that the payload data symbols and channel coefficients which are respectively used for calculations of the dividend and the divisor each relate to the same time period.

This means that the interval [B_TS_NData, E_TS_NData] is matched to the time interval in which the dedicated payload data symbols

$${x}_{m , k}^{Data}$$

are obtained for calculation of the dividend in equation (6). The interval [B_TS_NData, E_TS_NData] matched in this way is represented by a bar in FIG. 2.

In this case, it should be remembered that, although integration is carried out over the entire interval [B_TS_NData, E_TS_NData], the first channel coefficients h_{j,m}^{C} (i) to be integrated are, however, available only after the first two pilot symbols A and −A received in the time slot.

Furthermore, the interval [B_TS_NPilot, E_TS_NPilot] is matched to the time interval in which the channel coefficients h_{j,m}^{D} obtained from the dedicated pilot symbols are obtained for calculation of the dividend in equation (7). The interval [B_TS_NPilot, E_TS_NPilot] is likewise represented by a bar in FIG. 2.

In the case of equation (6), the simultaneous integration limits for the dividend and for the divisor mean that both the dedicated payload data symbols

$${x}_{m , k}^{Data}$$

and the common pilot symbols from which the channel coefficients h_{j,m}^{C} (i) are calculated have been subject to the same channel influences during their transmission. These channel influences are then cancelled out when forming the quotient in equation (6).

The channel influences are also cancelled out in an analogous manner when forming the quotient of equation (7).

The intervals [B_TS_NData, E_TS_NData] and [B_TS _NPilot, E_TS_NPilot] cannot, however, be predetermined to be fixed, permanently, but must in each case be matched to the UMTS time slot format. By way of example, FIG. 3 shows how the two intervals must be selected for the UMTS time slot format 15B.

It is possible to provide for the respective integration limits B_TS_NData, E_TS_NData, B_TS_NPilot and E_TS_NPilot to be stored in a ROM table as a function of the UMTS time slot format. This makes it possible to access the integration limits quickly, depending on the time slot format.

A further possible way to determine the intervals [B_TS_NData, E_TS_NData] and [B_TS_NPilot, E_TS_NPilot] is to select the integration limits as a function of the relative velocity of the mobile station with respect to the base station.

If the relative velocities are high, the channel characteristics can change quickly. In this case, it is therefore recommended that the integration limits be selected on the basis of the method described above. This eliminates fading dips, thus leading to a performance gain.

If the relative velocities are low, the channel characteristics do not change significantly over the time period of one time slot. Thus, in this case, the integration for calculation of the divisors in equations (6) and (7) may be carried out over the entire time slot. This results in improved statistics.

The boundary between the two described modes can be predetermined by means of a velocity limit.

Although the invention has been illustrated and described with respect to one or more implementations, alterations and/or modifications may be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

1. A method for calculation of path weights for the equalization of a data signal, that is transmitted from a base station via a data channel whose power is regulated, in a RAKE receiver in a mobile station, comprising:
calculating at least one uncorrected path weight for the data signal that is transmitted via the data channel whose power is regulated, using channel estimation results obtained on the basis of a common pilot channel;
calculating a correction factor, that comprises a ratio of a first estimated gain value, that is related to the data channel whose power is regulated, to a second estimated gain value, that is related to the common pilot channel, with the common pilot symbols that are used for calculation of the second estimated gain value being selected as a function of the relative velocity of the mobile station with respect to the base station or of the position and number of the symbols that are used for calculation of the first estimated gain value; and
correcting the at least one uncorrected path weight by multiplying it by the correction factor.

2. The method according to claim 1, wherein the second estimated gain value is calculated using common pilot symbols that have been transmitted largely at the same time as the symbols that are used for calculation of the first estimated gain value.

3. The method according to claim 1, wherein if the relative velocity of the mobile station with respect to the base station is above a predetermined limit value, the second estimated gain value is calculated using common pilot symbols that have been transmitted largely at the same time as the symbols that are used for calculation of the first estimated gain value.

4. The method according to claim 3, wherein if the relative velocity of the mobile station with respect to the base station is below the predetermined limit value, the common pilot symbols that are transmitted in a predetermined time interval within one time slot are used for calculation of the second estimated gain value.

5. The method according to claim 1, wherein the correction factor comprises
$$f = \frac{{W}_{D}}{{W}_{C}} \cdot \frac{1}{{σ}_{D}^{2}} ,$$
where W_{D} is an estimated value for the transmitter gain of the data channel whose power is regulated, W_{C} is an estimated value for the transmitter gain of the common pilot channel, and σ_{D}² is an estimated value for the noise variance on the data channel whose power is regulated.

6. The method according to claim 1, wherein the second estimated gain value is calculated from channel coefficients that have previously been calculated from the selected common pilot symbols.

7. The method according to claim 1, wherein the data channel whose power is regulated comprises a DPCH channel based on the UMTS Standard.

8. The method according to claim 1, wherein in calculating at least one uncorrected path weight, two or more uncorrected path weights are calculated for two or more transmission paths of the data signal, and in correcting the at least one uncorrected path weights, the uncorrected path weights are multiplied by the same correction factor.

9. The method according to claim 1, wherein the first estimated gain value is calculated using dedicated payload data symbols or dedicated pilot symbols.

10. The method according to claim 1, wherein the common pilot symbols that are used for calculation of the second estimated gain value are selected as a function of the antenna diversity.

11. The method according to claim 1, wherein the time slot formats for signal transmission based on the UMTS Standard are stored in a memory together with the associated interval boundaries (B_TS_NData, E_TS_NData, B_TS_NPilot, E_TS_NPilot) within which the common pilot symbols are used for calculation of the second estimated gain value, and in calculating the correction factor, the interval boundaries (B_TS_NData, E_TS_NData, B_TS_NPilot, B_TS_NPilot) are output from the memory as a function of the time slot format.

12. An apparatus for calculation of path weights for the equalization of a data signal, that is transmitted from a base station via a data channel whose power is regulated, in a RAKE receiver in a mobile station, comprising:
first means for calculating at least one uncorrected path weight for the data signal that is transmitted via the data channel whose power is regulated, using channel estimation results obtained on the basis of a common pilot channel;
second means for calculating a correction factor that comprises a ratio of a first estimated gain value, that is related to the data channel whose power is regulated, to a second estimated gain value, that is related to the common pilot channel, with the selection of the common pilot symbols that are used for calculating the second estimated gain value depending on the relative velocity of the mobile station with respect to the base station or on the position and number of the symbols that are used for calculating the first estimated gain value; and
third means for correcting the at least one uncorrected path weight by multiplying it by the correction factor.

13. The apparatus according to claim 12, wherein the second estimated gain value is calculated by the second means using common pilot symbols that have been transmitted largely at the same time as the symbols that are used for calculation of the first estimated gain value.

14. The apparatus according to claim 12, wherein if the relative velocity of the mobile station with respect to the base station is above a predetermined limit value, the second estimated gain value is calculated by the second means using common pilot symbols that have been transmitted largely at the same time as the symbols that are used for calculation of the first estimated gain value.

15. The apparatus according to claim 14, wherein if the relative velocity of the mobile station with respect to the base station is below the predetermined limit value, the common pilot symbols which are transmitted in a predetermined time interval within one time slot are used by the second means for calculation of the second estimated gain value.

16. The apparatus according to claim 12, wherein the correction factor comprises
$$f = \frac{{W}_{D}}{{W}_{C}} \cdot \frac{1}{{σ}_{D}^{2}} ,$$
where W_{D} is an estimated value for the transmitter gain of the data channel whose power is regulated, W_{C} is an estimated value for the transmitter gain of the common pilot channel, and σ_{D}² an estimated value for the noise variance on the data channel whose power is regulated.

17. The apparatus according to claim 12, wherein the second estimated gain value is calculated by the second means from channel coefficients that have previously been calculated from the selected common pilot symbols.

18. The apparatus according to claim 12, wherein the data channel whose power is regulated comprises a DPCH channel based on the UMTS Standard.

19. The apparatus according to claim 12, wherein the first means calculates two or more uncorrected path weights for two or more transmission paths of the data signal, and the third means multiplies the uncorrected path weights, as calculated by the first means, by the same correction factor.

20. The apparatus according to claim 12, wherein the first estimated gain value is calculated by the second means using dedicated payload data symbols or dedicated pilot symbols.

21. The apparatus according to claim 12, wherein the common pilot symbols that are used for calculation of the second estimated gain value by the second means are selected as a function of the antenna diversity.

22. The apparatus according to claim 12, further comprising a memory in which the time slot formats for signal transmission based on the UMTS Standard are stored together with the associated interval boundaries (B_TS_NData, E_TS_NData, B_TS_NPilot, E_TS_NPilot) within which the common pilot symbols are used for calculation of the second estimated gain value.

23. A method for calculation of path weights for the equalization of a data signal, that is transmitted from a base station via a data channel whose power is regulated, in a RAKE receiver in a mobile station, comprising:
calculating at least one uncorrected path weight for the data signal that is transmitted via the data channel whose power is regulated, using channel estimation results obtained on the basis of a common pilot channel;
calculating a correction factor that is a function of a relative velocity of the mobile station with respect to the base station; and
correcting the at least one uncorrected path weight using the correction factor.

24. The method of claim 23, wherein the calculation factor further comprises a ratio of a first estimated gain value, that is related to the data channel whose power is regulated, to a second estimated gain value, that is related to the common pilot channel, with the common pilot symbols that are used for calculation of the second estimated gain value being selected as a function of the relative velocity of the mobile station with respect to the base station or of the position and number of the symbols that are used for calculation of the first estimated gain value.
